(19) United States
(12) Patent Application Publication
(10) Pub. No.: US 2010/0080407 A1
(43) Pub. Date: Apr. 1, 2010

(54) Hearing aid device with a directional microphone system as well as method of operating such a hearing aid device

(76) Inventor: Herve Schulz, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/564,940

(22) Filed: Sep. 23, 2009

(30) Foreign Application Priority Data
Sep. 26, 2008 (DE) 10 2008 049 086.5

(51) Int. Cl. H04R 25/00

(52) U.S. Cl. 381/313

(57) ABSTRACT

In a hearing aid device with a directional microphone system it is always to be possible to set the highest possible level of both directional effect and also amplification. To this end it is proposed that the directional effect be set as a function of the amplification set at the time. In particular a maximum directional effect that cannot be exceeded is defined depending on the amplification and stored in the hearing aid device. This makes it possible for the user to always have the greatest possible degree of directional effect with his hearing aid device.

### CROSS REFERENCE TO RELATED APPLICATIONS

This application claims priority of German application No. 10 2008 049 086.5 filed Sep. 26, 2008, which is incorporated by reference herein in its entirety.

### FIELD OF THE INVENTION

The invention relates to a hearing aid device as well as to a method for operating a hearing aid device with a directional microphone system for picking up an acoustic input signal and creating at least one electrical microphone signal.

### BACKGROUND OF THE INVENTION

In a hearing aid device an input signal is picked up and converted into an electrical input signal by means of an input converter. Usually at least one microphone serves as an input converter which picks up an acoustic input signal and converts it into an electrical input signal. Modern hearing aid devices frequently comprise a directional microphone system with a number of microphones, in order to obtain reception dependent on the direction of incidence of acoustic signals, a directional characteristic. However telephone coils or antennas for picking up electromagnetic input signals and conversion in electrical input signals are also usual as input converters. The input signals converted by the input converter into electrical input signals are fed for further processing and amplification to a signal processing unit. The further processing and amplification is undertaken to compensate for the individual hearing loss of a user, generally as a function of the signal frequency of the input signal. The signal processing unit delivers at its output an electrical output signal which is fed via at least one output converter to the hearing of the hearing aid device wearer, so that the latter perceives the output signal as an acoustic signal. Earpieces that create an acoustic output signal are usually used as output converters. However output converters for creating mechanical oscillations are also known, which excite specific parts of the hearing, such as the ossicles of the middle ear for example, into oscillations. Output converters are further known that stimulate nerve cells of the hearing directly. A hearing aid device further comprises a power source (battery or rechargeable cell) for supplying power to the electronic components. Furthermore controls (on/off switch, program selection switch, volume control etc.) can also be present.

Apparatus for classification of hearing situations is used in modem hearing aid devices. The transmission parameters of the hearing aid device will be varied automatically depending on the hearing situation. In such cases the classification can be one of the factors influencing the amplification of the electrical input signal, the way in which interference noise suppression algorithms operate or the directional microphone system. Thus for example, depending on the hearing situation detected, a selection is made (discretely switched over or continuously cross faded) between an omnidirectional directional characteristic (zero-order directional characteristic) and a clear directional effect of the microphone system (first-order or higher-order directional characteristic). Gradient microphones are used to create the directional characteristic or a number of omnidirectional microphones are electrically connected to one another.

A hearing aid device with a directional microphone system is known from DE 103 31 956 B3 that comprises a number of omnidirectional microphones connected electrically to one another and for which different directional effects can be set. With the known hearing aid device the sound quality, especially in a quiet hearing environment, is to be improved. To achieve this aim it is proposed to increase the signal delay for at least one microphone signal such that a boosting of the transmission function occurs in the frequency curve of the microphone system, which also improves the signal-to-noise ratio by reducing the proportion of microphone noise in the microphone output signal.

It is known to the person skilled in the art of hearing aid devices that a hearing aid device tends to produce feedback at very high amplification if a high degree of directional effect is set for the directional microphone system used. Therefore with very high amplifications (e.g. greater than 100 dB), the directional microphone system is only used in omnidirectional operation, i.e. without any directional effect. With hearing aid devices for hearing aid wearers with severely impaired hearing who need a comparatively high amplification especially for quiet acoustic input signals, the directional effect was thus set beforehand as a function of the signal level of the acoustic input signal. Thus the maximum directional effect of the directional microphone system used was only allowed above a specific signal level of the acoustic input signal, or if a high degree of directional effect was also demanded with a lower signal level of the acoustic input signal, amplification was lowered accordingly.

Previously both the setting of the amplification and also the setting of the directional effect were undertaken respectively as a function of the result of an analysis of one or of a number of microphone signals or from the signal or signals preceding the microphone signals. In such cases the greatest possible degree of directional effect was determined by the signal level of the acoustic input signal.

### SUMMARY OF THE INVENTION

The object of the present invention is to always offer the hearing aid wearer the greatest possible degree of amplification and directional effect.

This object is achieved by a hearing aid device and by a method for operating a hearing aid device as claimed in the claims.

The hearing aid device comprises a signal processing unit for processing and amplification of the electrical microphone signal and creating an electrical output signal and an earpiece for conversion of the electrical output signal into an acoustic output signal, with different directional effects being able to be set for the directional microphone system and with the amplification able to be adjusted as a function of the result of an analysis of the microphone signal.

The invention brings the advantage of the greatest possible degree of directional effect, especially with a high level of amplification of the acoustic input signal by the hearing aid device, no longer being directly coupled to the signal level of the input signal. Instead the greatest possible level of directional effect for the inventive hearing aid device now depends directly on the amplification set. The difference from the previous method of operation is especially clear when the hearing aid device, despite a comparatively quiet input signal for which a high amplification would actually be required, only sets a comparatively low amplification. This is the case for example when the classifier detects that no useful signal component or only a small useful signal component is present in the acoustic input signal and that thus the input signal at least predominantly involves a noise signal. In this case it doesn't make any sense for the hearing aid device to select a high amplification. However it is of advantage for the user when the hearing aid device is currently in a hearing situation with a high noise signal component for the device to retain a highest possible level of directional effect for the directional microphone system used. Advantageously the highest possible degree of directional effect for a specific hearing situation now no longer depends on the level of the acoustic input signal, but directly on the amplification set. This fully exploits the technical possibilities of the hearing aid device concerned.

Advantageously a function is stored in the hearing aid device which defines the dependency of the directional effect on the amplification. In the simplest case of a hearing aid device with a directional microphone system containing two omnidirectional microphones able to be connected to each other electrically, this is a threshold value of the amplification, above which an omnidirectional (and thereby no) directional effect will always be set.

For a directional microphone system comprising more than two microphones, higher-order directional effects can be realized, e.g. for a directional microphone system with three omnidirectional microphones, first-order and second-order directional effects. In this case two threshold values for the amplification can be defined, with the hearing aid device concerned automatically selecting a second-order directional effect for an amplification below the lower threshold value, a first-order directional effect for an amplification between the two threshold values and a zero-order directional effect for an amplification above the upper threshold value. This method can principally be extended to directional microphone systems with any given number of microphones and thereby any given order of directional effects.

Furthermore it is also possible, as well as switching between different orders of directional effect as a function of discrete threshold values of the amplification, for a continuous and constant functional relationship between the amplification and the directional effect to be stored in the hearing aid device. Depending on the amplification set at that moment for the relevant hearing aid device, a degree of directional effect for the relevant directional microphone system is then selected and set.

Advantageously the inventively selected relationship between the directional effect and the amplification only defines in each case the greatest possible degree of directional effect for the respective amplification. This relationship can for example be determined by laboratory trials, so that, for the directional effect assigned to the respective amplification, a stable operation of the hearing aid device is always guaranteed. Naturally however an effect less than the greatest possible directional effect can always be set for the relevant amplification. If the hearing aid device detects, by analysis of one or more microphone signals or from signals preceding said microphone signals for example, that in the current hearing situation a directional effect is not required, no directional effect or also a lower directional effect than the maximum effect possible with the current amplification can also be set.

Up to this point the invention has been explained for the complete frequency spectrum able to be transferred with the hearing aid device concerned. With hearing aid devices the signal processing is undertaken however in parallel within individual frequency bands, the so-called channels. In this case both the setting of the amplification and also that of the directional effect can vary between the individual channels. The points discussed above in relation to one frequency band can naturally also be applied to a number of parallel frequency bands.

### BRIEF DESCRIPTION OF THE DRAWINGS

The invention will be explained in greater detail below with reference to an exemplary embodiment. The figures show:

FIG. 1 a greatly simplified block diagram of an inventive hearing aid device,

FIG. 2 a first example of the relationship between the amplification setting and the directional effect and

FIG. 3 a second example of the relationship between the amplification setting and the directional effect.

### DETAILED DESCRIPTION OF THE INVENTION

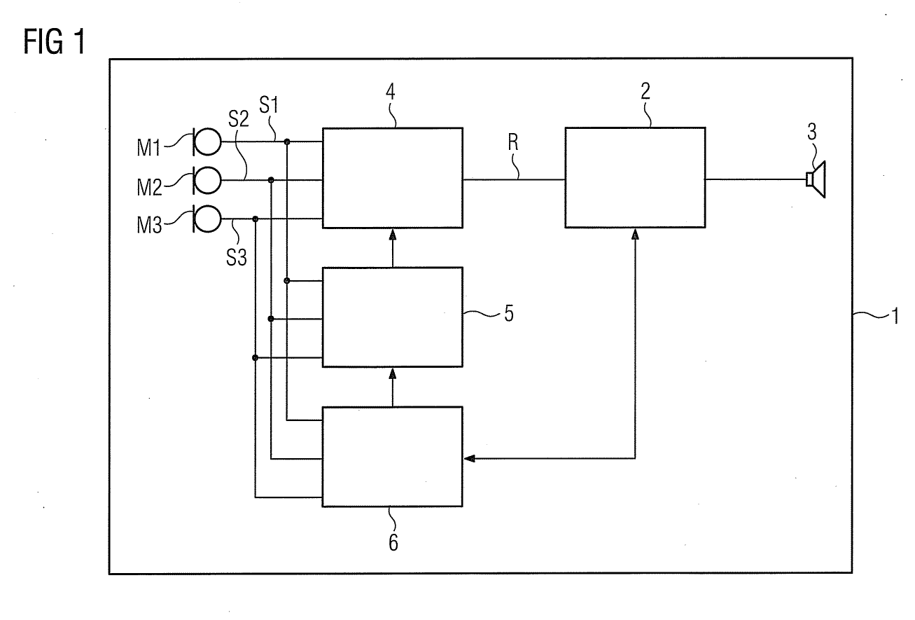

FIG. 1 shows a greatly simplified block diagram of a hearing aid device 1 with three microphones M1, M2 and M3, which pick up an acoustic input signal and create three electrical microphone signals S1, S2 and S3. The three microphones M1, M2 and M3, together with a microphone connection unit 4, form a directional microphone system, of which the directional effect is able to be changed by different connection of the microphones M1, M2 and M3 and different delays of the microphone signals S1, S2 and S3 in the microphone connection unit 4. The microphone connection unit 4 delivers at its output a directional microphone signal R, which is fed for further processing and frequency-dependent amplification to a signal processing unit 2. The processed and amplified directional microphone signal is finally converted by an earpiece 3 into an acoustic output signal and supplied to the hearing of a user of the hearing aid device 1.

The hearing aid device 1 is able to be adapted manually (by manual program switchover) and automatically to different hearing situations. The adaptation is undertaken especially by setting parameters that determine the signal processing in the signal processing unit 2. An analysis of the microphone signals S1, S2 and S3 is undertaken for this purpose in an analysis and control unit 6 for automatic determination of the parameter settings suitable for the respective hearing situation. By means of this analysis the hearing situation, in which the respective hearing aid device 1 currently finds itself, is automatically recognized and suitable parameter settings are determined and set in the signal processing unit 2. The level of the amplification of an acoustic input signal is especially defined in this way by the hearing aid device 1, with as well as the signal analysis, further factors also being able to influence the amplification, such as a manual volume setting which the user undertakes for example by means of a remote control on the hearing aid device 1.

A further automatic adaptation of the hearing aid device 1 to the current hearing situation relates to the directional microphone system. Here too control is exercised by a signal analysis of the microphone signals S1, S2 and S3, which is undertaken for this purpose in a directional microphone control unit 5. In this case the noise signal component and the directions of incidence of acoustic signals in particular determine the directional effect in the directional microphone system, which is then set by means of the microphone circuit unit 4.

A further parameter included in the determination and setting of the directional effect for the inventive hearing aid device 1 is also the amplification currently set for the hearing aid device 1 in the signal processing unit 2.

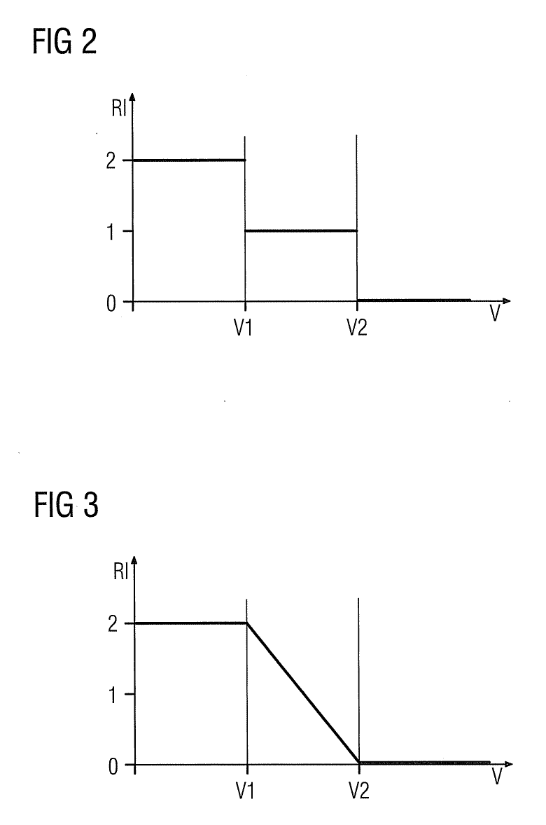

The relationship between the maximum directional effect and the amplification is illustrated by FIG. 2. With the directional microphone system with the three omnidirectional microphones M1, M2 and M3 of the hearing aid device 1 connected electrically to one another, zero-order, first-order and second-order directional effects can be realized. To this end, in the diagram depicted in FIG. 2, a directional effect index RI is plotted against the amplification V. “0” in this diagram stands for a zero-order directional characteristic (i.e. no directional effect), “1” for a first-order directional characteristic and “2” for a second-order directional characteristic. Up to a threshold value V1 of the amplification no upper limit of the directional effect is thus produced. The maximum possible second-order directional characteristic with the directional microphone can be set. Between the first threshold value V1 and the second threshold value V2 only a first-order directional characteristic is the maximum possible and above the threshold value V2 there must be no directional effect at all.

As has already been mentioned, the diagrams merely reflect the maximum possible directional effect depending on the amplification, in which stable operation of the hearing aid device concerned is guaranteed. Naturally a lower directional effect can always be set.

A further example from a plurality of possible functions is shown in FIG. 3. Here to a directional effect index RI is plotted against the amplification V. A difference compared to the example depicted in FIG. 2 emerges in the area between the threshold values V1 and V2, with a linear drop in the directional effect from a second-order directional characteristic to a zero-order directional characteristic being produced here. Such a relationship can for example be achieved by a specific control of the time constant in the microphone connection unit 4 as depicted in FIG. 1.

Advantageously the relationship between the amplification and the maximum directional effect, as has been roughly described with the aid of FIGS. 2 and 3, is held in hearing aid device 1, for example in a memory of the directional microphone control unit 4.

1-8. (canceled)

9. A hearing aid device, comprising:
a directional microphone for picking up an acoustic input signal and creating an electrical microphone signal;
a signal processing unit for processing and amplifying the electrical microphone signal based on the electrical microphone signal and creating an electrical output signal; and
an earpiece for converting the electrical output signal into an acoustic output signal,
wherein the directional microphone is configured to be set for a directional effect based on the amplification.

10. The hearing aid device as claimed in claim 9, wherein a function of the directional effect depending on the amplification is stored in the hearing aid device and the directional effect is set in accordance with the function.

11. The hearing aid device as claimed in claim 9, wherein a function of a maximum directional effect depending on the amplification is stored in the hearing aid device and a degree of the directional effect is set for not exceeding the maximum directional effect.

12. The hearing aid device as claimed in claim 9, wherein at least a zero-order directional effect and a first-order directional effect are set.

13. The hearing aid device as claimed in claim 12, wherein the first-order directional effect is set below a threshold value of the amplification and the zero-order directional effect is set above the threshold value.

14. A method for operating a hearing aid device, comprising:
picking up an acoustic input signal and creating an electrical microphone signal by a directional microphone;
processing and amplifying the electrical microphone signal based on the electrical microphone signal and creating an electrical output signal by a processing unit;
converting the electrical output signal into an acoustic output signal by an earpiece; and
setting a directional effect of the directional microphone based on the amplification.

15. The method as claimed in claim 14, wherein a function of the directional effect depending on the amplification is stored in the hearing aid device and the directional effect is set automatically in accordance with the function.

16. The method as claimed in claim 14, wherein a function of a maximum directional effect depending on the amplification is stored in the hearing aid device and the directional effect is set automatically for not exceeding the maximum directional effect.

17. The method as claimed in claim 14, wherein at least a zero-order directional effect and a first-order directional effect are set.

18. The method as claimed in claim 17, wherein the first-order directional effect is set automatically below a threshold value of the amplification and the zero-order directional effect is set automatically above the threshold value.
